(19) United States
(12) Patent Application Publication
(10) Pub. No.: US 2024/0411295 A1
(43) Pub. Date: Dec. 12, 2024

(54) MONITORING THE PRODUCTION OF MATERIAL BOARDS, IN PARTICULAR ENGINEERED WOOD BOARDS, IN PARTICULAR USING A SELF-ORGANIZING MAP

(71) Applicants: FRAUNHOFER-GESELLSCHAFT ZUR FÖRDERUNG DER ANGEWANDTEN FORSCHUNG E.V., München (DE); Dieffenbacher GmbH Maschinen- und Anlagenbau, Eppingen (DE)

(72) Inventors: Julius PFROMMER, Karlsruhe (DE); Constanze HASTEROK, Karlsruhe (DE); Josephine REHAK, Karlsruhe (DE); Jürgen WOLL, Eppingen (DE); Patrick STÖRNER, Eppingen (DE)

(73) Assignees: FRAUNHOFER-GESELLSCHAFT ZUR FÖRDERUNG DER ANGEWANDTEN FORSCHUNG E.V., München (DE); Dieffenbacher GmbH Maschinen- und Anlagenbau, Eppingen (DE)

(21) Appl. No.: 18/570,218

(22) PCT Filed: Jun. 14, 2022
(86) PCT No.: PCT/EP2022/066201

§ 371 Date: Sep. 2, 2024

(30) Foreign Application Priority Data
Jun. 14, 2021 (DE) 10 2021 206 044.7

(51) Int. Cl. G05B 19/418

(52) U.S. Cl. CPC G05B 19/41875; G05B 2219/32119

(57) ABSTRACT

The invention relates to methods for monitoring the production of a material board, in particular an engineered wood board, in particular by means of a self-organizing map (SOM) that has been trained accordingly.

The invention relates to methods for monitoring the production of a material panel, in particular a wood-based material panel, in particular by means of an appropriately taught self-organizing map, SOM.

In the production of material panels, in particular wood-based panels and preferably chipboard panels such as coarse chipboard (OSB), chipboard and medium-density fiberboard (MDF), a large number of production or process steps are connected in series. The main steps typically include wood chipping, chip sorting, chip filtering, chip drying, gluing, spreading and pressing. All processes are monitored by a plurality of sensors. The information obtained in the form of the acquired sensor data is typically only partially used for automatic control of the respective process steps or the entire production chain. This is primarily due to the complexity of wood as a material and the manufacturing process.

Accordingly, product quality losses caused by anomalies in the process are often only detected after a delay of several hours in complex laboratory measurements of random samples. Similarly, many production disruptions that develop over a longer period of time are not recognized at an early stage, which then lead to long system downtimes and material losses (wood and glue).

A human expert, who generally has years of experience in operating the production equipment used, then adjusts the respective production parameters in the various production steps or the entire production process based on their personal experience. They also monitor fault messages or displays from the control system in order to recognize production-relevant changes. However, fault messages or alarms in control systems usually only appear when defined values, e.g. limit values, are exceeded or undercut. Process-related anomalous values in a production cycle cannot be detected by conventional control programs in all states of such a complex process. Of course, such an expert can also use the current sensor data to detect deviations, i.e. anomalies, in the respective production steps and correct the corresponding production parameters. In both cases, know-how is used that has been built up over many years, cannot be comprehensively documented and is therefore difficult to pass on. Accordingly, the risk of default is considerable.

In addition, the material panel production plants, in particular wood-based panel production plants, are generally very large, i.e. a production plant with the associated production machines connected in series, which implement the respective (successive) production steps, typically have a length of several hundred meters. As a result, production is difficult to monitor, as there is often no overview of the entire production plant on site at a particular production machine. An additional complicating factor here, particularly with wood-based materials, is that the working materials are subject to large fluctuations, for example in moisture and/or hardness, but at the same time fluctuations in the starting materials and also the individual production steps can often be compensated for in subsequent production steps, or are caused by previous production steps. Therefore, a significant deviation of an actual value from a target value is not necessarily a quality defect or a clear indication of a production fault, which further complicates the monitoring of the production of such material panels, especially wood-based panels.

The technical object is therefore to make the production of material panels, in particular the production of wood-based panels, and especially the continuous production of wood-based panels, more manageable.

This object is achieved by the subject matter of the independent claims. Advantageous embodiments are shown in the dependent patent claims and the description.

One aspect relates to a training method for a self-organizing map (SOM) for monitoring the production of a material panel, in particular a wood-based material panel such as an OSB and/or MDF and/or chipboard. Production is preferably a continuous production process with a large number of production steps (particularly in series), in which the raw product is passed on to the next production step in a form that has been refined in each production step. A SOM is often also referred to as a Kohonen map or Kohonen network. Such SOMs are a type of artificial neural network that maps multidimensional input data from an input data space to a planar structure, the map space, as an unsupervised training method. This creates a topological feature map.

A process step of the training method is the respective acquisition of sensor data in one or more of the (in particular successive) production steps in the production of the material panel. This acquisition or provision is carried out by the respective sensors of the assigned (material panel) production plant. The material panel production plant can be divided into different production machines as an overall production plant, which are assigned to the respective production steps. Sensor data is therefore preferably acquired in at least one such production step, but preferably in several or all production steps. In each and therefore for each production step, a variety of sensor data can be acquired or provided by a variety of respective sensors of the production machine. However, it is also possible to acquire or provide sensor data from a single sensor of a production machine and thus a production step. Each production step can be assigned several sensors of different types as well as several sensors of the same type, or mixtures of different and similar sensors. For example, in one production step, a temperature can be detected by a temperature sensor and a pressure can be acquired by a series of several pressure sensors, i.e. sensors of the same type. The sensor data is then provided to a computing unit accordingly. The acquired or provided sensor data can be partially or completely pre-processed by the computing unit before further steps, as described below. Sensor data from similar sensors can provide data in the same units or units that can be converted into each other.

The sensor data is preferably scaled by means of one or more statistical methods after it has been acquired and before further process steps such as the still described training, the still described mapping to a two-dimensional map space, the still described determination of distances and/or also the pre-processing. Preferably, both the sensor data used to teach the SOM and the sensor data evaluated by the SOM (distance calculation to reference points, mapping into the two-dimensional map space, etc.) are scaled. Scaling can be understood here to mean that a scaling factor is calculated on the basis of the training data, the sensor data used for teaching, which ensures that the distribution within each characteristic or “feature” of the production, i.e. within all measured values of a sensor, has a mean value of 0 and a standard deviation of 1. Other scalings are also possible, such as scaling the distribution to a value range between 0 and 1. The scaling factor determined during training is then always applied to both the training data and the data that is to be evaluated, which makes the sensor data comparable and ensures reliable processing by the SOM.

A further method step is the training of the self-organizing map with the sensor data, which may be pre-processed or partially pre-processed or not pre-processed, i.e. the acquired sensor data as such. However, all of the sensor data mentioned are preferably scaled in the sense described. The self-organizing map maps an input data space of the sensor data (also called observation space) spanned by the pre-processed and/or acquired sensor data onto a two-dimensional grid, the map space. The input data space has correspondingly many (more than two) dimensions, in particular as many dimensions as there are (temporally parallel) sensor measurements. Both spaces are to be understood here as spaces in the mathematical sense. In the input data space of the sensor data, the set of all sensor measurements that took place at the same time or with a predefined time offset (such as pressure, temperature and the variables or parameters specified in more detail below) each determines a sensor data point. The sensor data points are therefore vectors in the input data space or observation space. Since the sensor data points are located in the input data space as an observation space, they can also be referred to as observation points. Reference points are learned in the observation space, which represent a density distribution of the pre-processed and/or acquired sensor data. The density distribution can be understood as the distribution of data points in the observation space. Each reference point corresponds to a node on the two-dimensional grid in map space. Teaching takes place in a computing unit which is coupled directly or indirectly, for example via a sensor database, with the sensors.

This has the advantage that an unsupervised training method is used and training data does not have to be used to evaluate the model in the planning or monitoring procedure described below. Since the learned model essentially consists of the reference points in the observation space and their equivalent in the map space, very little memory is required and the evaluation of the model is also carried out quickly for a given data point. It has also been shown that the training method is very robust for given material panel production plants, especially material panel production plants designed for continuous production, despite the large number of strongly varying sensor data.

The training method can also be applied analogously to other mathematical methods. The described training method can therefore also include an equivalent unsupervised learning procedure with the same effect instead of the described SOM.

In an advantageous embodiment, it is provided that the sensor data is verified with a predefined filter criterion, whereby the training takes place exclusively with sensor data that fulfills the predefined or specifiable filter criterion. In particular, the filter criterion can include a minimum operating time of a production machine with the sensor associated with the respective sensor data and/or a minimum degree of temporal convergence of the values of the sensor data of the corresponding sensor. For this purpose, the sensor data can be linked to other data, for example via a corresponding time stamp, from which, for example, the said minimum operating time of the production machine or other circumstances to be assigned to the sensor data can be derived. This has the advantage that the learning process is improved and, in particular, the self-organizing map that has been taught is also more robust with regard to anomalies in later applications or recognizes them better.

In a further advantageous embodiment, it is provided that the sensor data have a time stamp and that the sensor data whose time offset according to the time stamp corresponds to a time offset of the (in particular successive) production steps belonging to the different sensor data are used in correlation for teaching the self-organizing map. Sensor data relating to the same batch of material panels or the same production recipe, for example, are correlated and used for teaching. The time offset of the production steps performed on a given material panel during production is thus compensated for by the corresponding time offset of the sensor data used to teach the self-organizing map. This has the advantage that the sensor data used relates to the same material panel and is therefore much better suited for planning and monitoring the production of the respective material panel, whose properties are ultimately of interest. This is equally advantageous for monitoring production faults, as the individual production steps are linked via the material panels and production recipes. This makes the self-organizing map even more robust and more reliable in detecting an anomaly or predicting a quality.

A further aspect relates to a method for monitoring said production of a material panel.

Monitoring production can include monitoring product quality and/or monitoring the production plant itself, wherein the latter also allows production faults that are developing over a longer period of time to be detected at an early stage, i.e. before system downtimes and material loss. The method uses available measured values to gain more reliable insights into the condition of the production plant.

A method step is again a respective acquisition or provision of sensor data in the (in particular successive) production steps of the production of the material panel by the respective sensors of the material panel production plant. As before, some or all of the acquired sensor data can be pre-processed, as described below. The pre-processed and/or acquired or provided sensor data can be evaluated by a computing unit using reference points as described in more detail below.

Accordingly, a further method step is a determination of reference points in a multidimensional input data space of the sensor data available during a complete acquisition, the observation space, wherein the reference points represent a density distribution of (preferably completely acquired) sensor data in the observation space. Complete can mean here that values have actually been acquired for all of the sensor data that is to be monitored. The observation space can therefore explicitly not include all sensor data theoretically available in the production process, but only that which is to be acquired for monitoring purposes. The reference points known from the teach-training method described above, which were learned with the SOM or another learning procedure, can be used here. Alternatively, the reference points can also be determined using other methods, for example by determining one or more centers of gravity of the density distribution or similar. One example here is a cluster analysis in which clusters are identified in the sensor data, a center of gravity is calculated for each cluster and the centers of gravity then form the respective reference points.

A method step is a determination of at least one distance and/or at least one average distance value between an observation point corresponding to the acquired sensor data, a sensor data point in the multi-dimensional input data space, and at least one closest reference point in the observation space by the computing unit. The distances between the observation point and several nearest reference points in the observation space can also be determined, whereby the distance referenced in the following is preferably the distance to the center of the reference points in this case. In a next method step, the production step and/or the sensor and/or the sensor group whose sensor data determine the determined distance and/or the determined average distance value, in particular determine the determined distance and/or the determined average distance value as the largest single factor and thus contribute the most to the corresponding deviation or anomaly, is determined by the computing unit. In particular, the individual contributions to the determined distance can also be determined for several or all production steps and/or sensors and/or sensor groups. This allows, for example, a ranking list sequence from which it can be seen how the calculated distance essentially comes about.

A further method step is a display of the at least one determined production step and/or the at least one determined sensor and/or the at least one determined distance and/or the at least one determined average distance value by a display unit, which can also be part of the computing unit. The distance can be understood and displayed as an anomaly indicator, as it has been shown to correlate with the occurrence of anomalies in the product and/or the production plant. The display can also take the form of an electronic signal to another electronic unit. Alternatively or additionally, an optical and/or acoustic warning can also be issued, for example if the determined production step and/or the determined sensor and/or the determined distance fulfill a predefined condition, as may be the case if the permissible maximum distance for the observation point from the nearest reference point described below is exceeded.

A further method step can be the issuing of a corresponding control instruction and/or verification rejection to a human operator. Alternatively or additionally, the determined production step or the production step of the wood-based panel production plant belonging to the determined sensor or sensor group can also be controlled accordingly.

This has the advantage that anomalies and thus potential quality losses and/or imminent production disruptions, especially production disruptions that develop over a longer period of time, which then lead to long system downtimes and material loss (wood and glue), can be detected at an early stage and appropriate countermeasures can be taken quickly. Parameters of the production plant can be specifically selected so that slowly developing faults in the production plant can be avoided. In particular, a user can be given specific information about where in production, in which production step and at which sensor anomalies occur or changes that are decisive for anomalies occurring.

In an advantageous embodiment, it is provided that a permissible maximum distance and/or permissible maximum average distance for the observation point/sensor data point from the nearest reference point or the nearest reference points is specified. In particular, the maximum distance/maximum distance mean value can be specified as a function of the quality indicator value associated with the at least one region in the map space. In this case, the acquired sensor data is also preferably mapped to the two-dimensional map space using the nearest reference point and its equivalent in the map space, for example by means of the trained SOM described above or a corresponding method by the computing unit. A verification is also made here as to whether the determined distance/the determined average distance value is greater than the permissible maximum distance/maximum average distance value and, if this is the case, in particular only if this is the case, the production step and/or the sensor is determined and, alternatively or additionally, the determined product step and/or sensor is displayed and, alternatively or additionally, a visual and/or acoustic warning and/or the control instruction and/or check instruction is issued to an electronic unit and/or a user. This has the advantage that production becomes even more controllable, as the computing unit can already decide or indicate that an anomaly that occurs, which is expressed in the determined distance/average distance value, is critical or not, and therefore requires intervention by a user or a control process or not. If a corresponding quality indicator value is also specified in the map space, statements can also be made on an ongoing basis about expected product quality and/or a possible developing fault, or it becomes clearer to the user to what extent a change in production, an anomaly, potentially entails a loss of quality and/or a fault in the production process or not.

The quality indicator value referenced here can be a relative quality indicator value that indicates a quality (in the sense of a property) not in absolute terms but as a deviation relative to a known property (i.e. in particular a property that has been tested in production and found to be suitable for production) in production, i.e. in particular a property of the product and/or the production rule.

In a further advantageous embodiment, it is provided that the sensor data have a time stamp and that for the evaluation of the sensor data or observation points, in particular by means of the self-organizing map (calculation of distances to reference points, and the further mentioned method steps or parts of method steps), those sensor data are used in correlation whose time offset according to the time stamp corresponds to a time offset of the production steps belonging to the different sensor data (in particular successive production steps). This provides the advantages of increased robustness and reliability already described above.

In another advantageous embodiment, it can be provided here that the computing unit offers a user an input option for manual input in a cause for the displayed production step and/or the displayed sensor and/or the displayed sensor group and/or the displayed distance and/or the displayed average distance value. Accordingly, the computing unit then learns a correlation between the displayed production step and/or the displayed sensor and/or the displayed sensor group and/or the displayed distance and/or the displayed average distance value of the underlying sensor data and/or the determined distance on the one hand and the entered cause on the other hand in a supervised learning mode of a learning algorithm. As a result, in an application mode of the learning algorithm taught in the supervised learning mode, a cause assigned to the displayed production step and/or the displayed sensor and/or the displayed sensor group and/or the displayed distance can then be displayed by the computing unit, based on the mapped sensor data and/or the determined distance and/or the determined average distance value underlying the displayed production step and/or the displayed sensor and/or the displayed sensor group and/or the displayed distance and/or the displayed average distance value. Confidence information regarding the displayed cause can also be displayed here to give the user an impression of the reliability of the displayed cause. It can thus be indicated, for example, that for a given anomaly of, for example, too high a temperature in a pressing step, a clogged glue nozzle was the cause or, if the confidence information is displayed, was the cause with a determined probability. In particular, a control instruction corresponding to the assigned cause can also be issued to a person or a machine. This has the advantage that even more knowledge is agglomerated in the computing unit and thus possibly in the production plant, which in turn increases the manageability of production.

In a further advantageous embodiment, it is provided that the production step or steps comprise or are a glue preparation step and/or a gluing step and/or a forming station step and/or a forming strand step and/or a pressing step, in particular in the order indicated. The methods described have proven to be particularly advantageous and effective in the production steps mentioned or the combination of production steps mentioned.

In a further advantageous embodiment, it is provided that the sensor data comprise or are at least one temperature of the material plate and/or the production plant and/or at least one humidity of the material plate and/or at least one filling level of the production plant and/or at least one valve or flap position of the production plant and/or at least one pressure of the production plant and/or at least one density of the material plate and/or at least one rotational speed of the production plant and/or at least one conveying speed of the production plant and/or at least one width of the material plate and/or at least one thickness of the material plate. The aforementioned sensor data is particularly meaningful for the production described and therefore allows the methods described to be used particularly effectively.

In a further advantageous embodiment, it is provided that some or all of the sensor data of at least one production step, preferably several or all production steps, are pre-processed by the computing unit by means of one or more statistical methods. In particular, the statistical method or methods may be or include normalization. Pre-processing takes place after acquisition of the sensor data and before the further processing steps. This has the advantage that the robustness of the methods can be increased and the total computational effort can be reduced.

It is particularly advantageous here if the static method or methods comprise or are an averaging and/or a median formation and/or a min-max differentiation and/or a variance formation of the respective sensor data of several sensors of the same type in a respective one or more production steps jointly assigned to the respective sensors and/or a temporal averaging and/or a temporal median formation and/or temporal min-max differentiation and/or a temporal variance formation of the respective sensor data of a respective sensor of one or more respective production steps. Min-max differentiation describes the calculation of the difference between a minimum and maximum sensor value. The statistical methods mentioned have the advantage that they are relatively simple from a mathematical point of view and at the same time have clear advantages in terms of the robustness and reliability of the methods described.

A further aspect relates to a device for carrying out one of the methods of the preceding claims, in particular a computing unit with suitable interfaces to the production plant.

Advantages and advantageous embodiments of the device or the computing unit correspond here to advantages and advantageous embodiments of the methods described.

The features and combinations of features mentioned above in the description, including in the introductory part, can be used not only in the combination indicated in each case, but also in other combinations, without departing from the scope of the invention. Thus, embodiments which are not explicitly shown and explained, but which arise from the explained embodiments and can be produced by separate combinations of features, are also to be regarded as comprised and disclosed by the invention. Embodiments and feature combinations that thus do not include all the features of an originally formulated independent claim shall also be considered to be disclosed. Additionally, embodiments and feature combinations, in particular as a result of the above-described embodiments, that go beyond or deviate from the feature combinations described in the dependency references of the claims shall be considered to be disclosed.

The invention is illustrated by two figures.

### IN THE DRAWINGS

FIG. 1 shows a three-dimensional observation space with reference points and observation points;

FIG. 2 shows the mapping of a multidimensional observation space onto a two-dimensional map space.

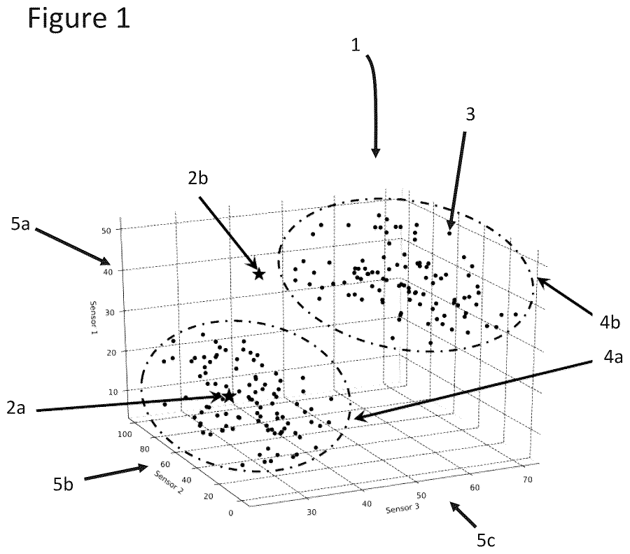

FIG. 1 shows reference points 3 and observation points 2a, 2b in a multidimensional observation space 1. A three-dimensional observation space 1 is shown as an example to illustrate this. Each dimension, i.e. each axis 5a, 5b, 5c of the observation space 1 represents a sensor of a production plant for material panels that can be read out. The sensors can provide data on various measured variables, such as temperature, air pressure, fill level or humidity. Regardless of which measured variable each sensor measures, the sensors can be arranged at different sections of the production plant. This allows data from different sections of the production plant to be acquired. It is also possible to imagine embodiments in which several sensors are arranged at different sections of the production plant and acquire data.

Reference points 3 are shown in FIG. 1. The reference points 3 are determined by a computing unit and represent a density distribution of completely acquired sensor data in the observation space 1. In the example shown in FIG. 1, the reference points 3 are arranged in two separate point clouds 4a, 4b. The two separated point clouds 4a, 4b can be interpreted as different normal operating conditions of the system.

FIG. 1 shows the sensor data acquired by the sensors as observation points 2a, 2b in the observation space 1. A first observation point 2a and a second observation point 2b are shown as examples. The two observation points 2a, 2b can, for example, represent the sensor data or the status of the production plant at two different points in time.

The computing unit can now be used to determine a distance or an average distance value between an observation point 2a, 2b and at least one nearest reference point 3 in the observation space 1. This can be used to determine whether the production plant is in a normal or abnormal operating condition. For example, the first observation point 2a lies within a first point cloud 4a of reference points. The second observation point 2b lies both outside the first point cloud 4a and outside the second point cloud 4b. In the example shown in FIG. 1, the distance between the first observation point 2a and the nearest reference point is smaller than the distance between the second observation point 2b and the nearest reference point. This may indicate, for example, that the first observation point 2a reflects a normal state of the production plant. The second observation point 2b may indicate an abnormal state of the production plant.

In a further process step, the computing unit can then determine which sensor or which sensor group or section of the production plant or which production step determines the distance to the nearest reference point. Looking at the second observation point 2b, for example, it is possible to determine which sensor or which sensor group or section of the production plant or which production step contributes significantly to the occurrence of an abnormal state.

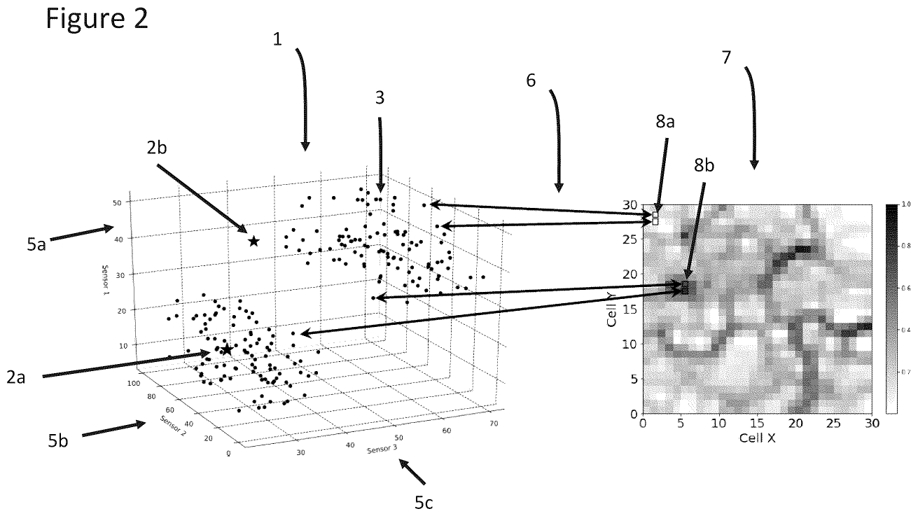

FIG. 2 shows an observation space 1 and a two-dimensional map space 7. The observation space 1 in FIG. 2 is the same three-dimensional observation space 1 already shown in FIG. 1.

The two-dimensional map space 7 is divided into cells 8a, 8b, each of which can be clearly assigned to a reference point 3 of the observation space 1. The assignment is visualized as an example by illustration arrows 6. The number of cells in map space 7 is therefore equal to the number of reference points 3 in observation space 1. Each cell of map space 7 is colored. The color of a cell is a measure of the distance between the associated reference point and the associated reference points of the neighboring cells. For example, a lighter coloration of the cell indicates that the reference points belonging to the neighboring cells are within the same point cloud. Cell 8a is an example of this. A darker color indicates reference points 3 that are located at the edge of different point clouds. Cell 8b is an example of this. Quality indicator values can be assigned to different regions of the two-dimensional map.

Acquired sensor data, i.e. observation points 2a, 2b, can be mapped by the computing unit in the two-dimensional map space 7. The mapping is carried out using the nearest reference point 3 and its equivalent in map space 7. This can be done by means of a trained neural network, in particular by means of a correspondingly trained self-organizing map.

In addition, a permissible maximum distance and/or permissible maximum average distance for the observation point/sensor data point from the nearest reference point or reference points can be specified. In particular, the maximum distance/maximum distance mean value can be specified as a function of the quality indicator value associated with the at least one region in the map space. It may also be verified whether the distance/mean distance value determined is greater than the permissible maximum distance/maximum mean distance value. If this is the case, in particular only if this is the case, the production step and/or the sensor that significantly determines this distance in the observation space can be determined, for example. Alternatively or additionally, the determined product step and/or sensor can be displayed and, alternatively or additionally, a visual and/or acoustic warning and/or the control instruction and/or verification instruction can be issued to an electronic unit and/or a user. This makes the production of material panels even more manageable.

Since this method essentially uses the reference points in the observation space and their equivalent in the map space, very little memory is required and the evaluation for an observation point can be carried out quickly. It has also been shown that this method is very robust for given material panel production plants, especially material panel production plants designed for continuous production, despite the large number of strongly varying sensor data.

### LIST OF REFERENCE SIGNS

1 observation space
2a first observation point
2b second observation point
3 reference point
4a first point cloud
4b second point cloud
5a first axis
5b second axis
5 third axis
6 mapping arrows
7 two-dimensional map space
8a first cell
8b second cell

1. A monitoring method for the production of a material panel, in particular a wood-based panel, comprising the method steps:
respective acquisition of sensor data in the production steps of the production of the material panel, by the respective sensors of the material panel production plant;
determination of reference points in a multidimensional input data space of the sensor data, the observation space, wherein the reference points represent a density distribution of completely acquired sensor data in the observation space, by a computing unit;
determination of a distance or average distance value between an observation point corresponding to the acquired sensor data and at least one nearest reference point in the observation space, by the computing unit;
determination of the production step and/or the sensor and/or the sensor group whose sensor data determine the determined distance or average distance value, by the computing unit;
display of the determined production step and/or the determined sensor and/or the determined sensor group and/or the determined distance and/or the determined average distance value, by a display unit.

2. The method according to the preceding claim,
characterized by a
specification of a permissible maximum distance or maximum mean distance value for the observation point from the at least one nearest reference point;
verifying whether the determined distance or average distance value is greater than the permissible maximum value; and, if yes:
determining the production step and/or the sensor, and/or displaying the determined production step and/or sensor, and/or outputting a visual and/or acoustic warning.

3. The method according to any one of the preceding claims,
characterized by a
mapping of the acquired sensor data onto a two-dimensional map space by the nearest reference point and its correspondence in the map space by means of a trained neural network, in particular by means of a self-organizing map trained in accordance with claims 6 to 8, by the computing unit; and
specifying a quality indicator value for at least one region in the map space, wherein the maximum distance is specified as a function of the quality indicator value associated with the at least one region in the map space.

4. The method according to any one of the preceding claims,
characterized in that
the sensor data have a time stamp and, for determining the reference points closest to an observation point, those sensor data are used in correlation whose time offset according to the time stamp corresponds to a time offset of the production steps belonging to the different sensor data, in particular successive production steps.

5. The method according to any one of the preceding claims,
characterized by a
providing an input option for manually entering a cause for the displayed production step and/or the displayed sensor and/or the displayed sensor group and/or the displayed distance and/or the displayed average distance value, by the computing unit, and
learning, in a supervised learning mode of a learning algorithm, a correlation between the sensor data underlying the displayed production step and/or the displayed sensor and/or the displayed sensor group and/or the displayed distance and/or the displayed average distance value on the one hand and the input cause on the other hand, by the computing unit; and/or
displaying, in an application mode of the learning algorithm taught in the supervised learning mode, a cause associated with the displayed production step and/or the displayed sensor and/or the displayed sensor group and/or the displayed distance and/or the displayed average distance value based on the sensor data underlying the displayed production step and/or the displayed sensor and/or the displayed sensor group and/or the displayed distance and/or the displayed average distance value.

6. A training method for a self-organizing board, SOM, for monitoring the production of a material panel, in particular a wood-based material panel, comprising the method steps:
respective acquisition of sensor data in one or more production steps of the production of the material panel, by respective sensors of an assigned material panel production plant;
training of the SOM by a computing unit with the sensor data, wherein the SOM maps a multidimensional input data space of the sensor data, the observation space, to a two-dimensional map space, wherein a density distribution of the sensor data in the observation space is represented by one or more learned reference points, and the learned reference points are mapped by the SOM to respective nodes in the map space.

7. The method according to the preceding claim,
characterized by
a verification of the sensor data with a predetermined filter criterion, wherein the training takes place exclusively with sensor data which fulfill the filter criterion, wherein in particular the filter criterion comprises a minimum operating time of a production machine with the sensor associated with the sensor data and/or a minimum degree of temporal convergence.

8. The method according to any one of the two preceding claims,
characterized in that
the sensor data have a time stamp and, for teaching the SOM, those sensor data are used in correlation whose time offset according to the time stamp corresponds to a time offset of the production steps belonging to the different sensor data, in particular successive production steps.

9. The method according to any one of the preceding claims,
characterized in that
the production step(s) comprise a glue preparation step and/or a gluing step and/or a forming station step and/or a forming strand step and/or a pressing step, in particular in the order indicated.

10. The method according to any one of the preceding claims,
characterized in that
the sensor data comprise or are at least one temperature of the material panel and/or of the production plant and/or at least one humidity of the material panel and/or at least one filling level of the production plant and/or at least one valve or flap position of the production plant and/or at least one pressure of the production plant and/or at least one density of the material panel and/or at least one rotational speed of the production plant and/or at least one conveying speed of the production plant and/or at least one width of the material panel and/or at least one thickness of the material panel.

11. The method according to any one of the preceding claims,
characterized by a
pre-processing of several of the sensor data of at least one production step by means of one or more statistical methods, in particular by means of normalization, by the computing unit.

12. The method according to the preceding claim,
characterized by one or more
statistical methods which comprise or are an averaging and/or a median formation and/or a min-max differentiation and/or a variance formation of the sensor data of several sensors of the same type in a production step jointly assigned to the respective sensors and/or a temporal averaging and/or a temporal median formation and/or a temporal min-max differentiation and/or a temporal variance formation of the sensor data of a respective sensor.

13. The method according to any one of the preceding claims,
characterized in that
the method is used to predict production downtimes.

14. The method according to any one of the preceding claims,
characterized in that
the method is used to detect changes in quality.

15. A device for carrying out one of the methods of the preceding claims, in particular a computing unit with suitable interfaces to the production plant.
